(19) United States
(12) Patent Application Publication
(10) Pub. No.: US 2025/0040701 A1
(43) Pub. Date: Feb. 6, 2025

(54) Method and Apparatus for Firearm Storage

(71) Applicant: Granite Security Products, Inc., Mansfield, TX (US)

(72) Inventors: Ethan P. Gonzalez, Weatherford, TX (US); Justin T. Walters, Mansfield, TX (US); Gregory K. Walters, Mansfield, TX (US)

(73) Assignee: Granite Security Products, Inc., Mansfield, TX (US)

(21) Appl. No.: 18/362,307

(22) Filed: Jul. 31, 2023

(51) Int. Cl. A47B 81/00; A47B 88/493; E05G 1/024; E05G 1/04

(52) U.S. Cl. CPC A47B 81/005; A47B 88/493; E05G 1/024; E05G 1/04

(57) ABSTRACT

A system for accessibly storing firearms in a safe includes a drawer configuration that permits the entire contents of the safe to be accessed by pulling the drawer away from the safe enclosure and accessing the firearms from the side(s) of the opened drawer. A rod storage system permits substantially vertical storage of firearms stored in the drawer by using a flanged top cap resting on top of a top rack that is connected to a guide rod inserted through an aperture in the top rack and into the bore of the barrel of a long gun. A handgun storage system is also disclosed, where lateral guide rods are disposed between vertical guide rod sections connected to a flanged top cap that rests on top of the top rack so that the lateral guide rods may be inserted into the barrels of handguns stored normal to the vertical guide rod(s).

### BACKGROUND

### 1. Field of the Disclosure

The present invention relates to a storage system for the more efficient storage and access of firearms in a safe storage system, whether in an enclosed safe, a closet, cabinet, or room.

### 2. Background of the Disclosure

Storage of firearms, both long guns (shotguns and rifles), handguns, rifles, revolvers, and pistols has historically presented issues regarding accessibility, efficient space utilization, and damage to firearms. While firearm safes, fireproof rooms and closets, and gun cabinets may be locked and thereby prevent unauthorized access, the internal storage is often cumbersome, requiring multiple firearms to be removed to access long guns not “on the front row. Additionally, there have been no noticeable known developments in firearms safes in the past 100 years or more. For example, safes have historically been constructed with a hinged door that supports the weight of the locking mechanism, exterior armor or skin, and any fire retardant material.

Operation of safes until now has required the entry of a combination or key to disable the locking mechanism(s) to allow the hinged door to swing open, providing access to the open area within the safe. A new system is needed to provide more complete access, more efficient storage, and a storage configuration that protects the finish and integrity of the firearms, by preventing firearms from falling over, or into one another during access.

Additionally, existing vertical firearm storage solutions, such as what is shown in U.S. Pat. No. 7,963,406 (the “'406 patent”) are flawed for two reasons. First, those solutions are not designed to be inserted through an apertured top plate or rack of a storage cabinet or safe. Rather, the '406 patent only teaches to stick the head of a gun rod to a hook-and-loop surface on the underside of a shelf or the roof of a safe. Thus, even retrofitting an existing safe using the prior art system would be problematic versus the system disclosed herein.

The present invention addresses the problems with the storage of firearms that have been ubiquitous in the current offerings of firearms safes, closets, rooms and cabinets, and have been prevalent since the invention of safes for firearms.

### SUMMARY OF THE INVENTION

In one embodiment, the present disclosure may include an enclosure system comprising one or more drawer units that open to provide access to firearms stored within. In this embodiment, the firearm safe includes a cabinet component sized to include a sliding or rolling drawer unit configured to store firearms. The safe enclosure preferably includes an exterior surface, an interior surface, one or more guide rails, and a vertical door.

In another embodiment, a cavity in the drawer unit includes a storage configuration that includes a top plate that include apertures that allow for a guide rod apparatus to be inserted therethrough from the top or bottom, that comprises a rod cap sized larger than the aperture, so that when the rod cap is engaged with the guide rod, the guide rode is suspended from the top plate. The guide rod may be inserted into the barrel of a firearm to hold the firearm in a position substantially coaxially with the orientation of the guide rod. In a preferred embodiment, multiple apertures are included in the top plate that permit multiple long guns to be stored in a substantially vertical orientation to permit storage and access to firearms stored along the length of the drawer unit. The guide rod may also include a barrel stabilizer to assist the rod assembly maintain the storage position of the firearm as well as protect the exterior finish of the barrel of the firearm.

In another embodiment, a guide rod system may be used to retrofit an existing safe to allow for the convenient vertical storage of long guns and handguns, by installing an apertured top rack or shelf within the enclosure of the safe, then utilizing the guide rod and top cap system to configure long guns and handguns safely and with adequate spacing within the enclosure.

### BRIEF DESCRIPTION OF THE DRAWINGS

FIG. 1 illustrates an example of the hinged door gun safe of the prior art;

FIG. 2A illustrates a front view of a firearm storage system in accordance with the principles of the present disclosure;

FIG. 2B illustrates a perspective view of a firearm storage system in accordance with the principles of the present disclosure;

FIG. 2C illustrates a left-side (from the front) of a firearm storage system in accordance with the principles of the present disclosure;

FIG. 2D illustrates a plan/top view of a firearm storage system in accordance with the principles of the present disclosure;

FIG. 2E illustrates a right-side (from the front) view of a firearm storage system in accordance with the principles of the present disclosure;

FIG. 2F illustrates a top rack in accordance with the principles of the present disclosure;

FIG. 2G illustrates a drawer center wall in accordance with the principles of the present disclosure;

FIG. 2H illustrates a storage drawer in accordance with the principles of the present disclosure;

FIG. 2I illustrates a drawer frame in accordance with the principles of the present disclosure;

FIG. 2J illustrates a drawer with slides in accordance with the principles of the present disclosure;

FIGS. 3A-3A″ illustrate various guide rod apparatuses in accordance with the principles of the present disclosure;

FIG. 3B illustrates a barrel stabilizer in accordance with the principles of the present invention;

FIG. 3C illustrates a guide rod section of a guide rod apparatus in accordance with the principles of the present disclosure;

FIG. 3D illustrates a top cap of the guide rod system in accordance with the principles of the present disclosure;

FIG. 3E illustrates an alternative push-turn version of a guide rod section and top cap of a guide rod system in accordance with the principles of the present disclosure;

FIG. 4 illustrates a perspective view of a handgun storage guide apparatus in accordance with the principles of the present disclosure;

FIG. 4A illustrates a side view of a handgun storage guide apparatus shown in FIG. 4 in accordance with the principles of the present disclosure; and

FIG. 4B illustrates various components of a handgun storage guide apparatus in accordance with the principles of the present disclosure.

### DETAILED DESCRIPTION OF THE INVENTION

The preferred version of the disclosure presented in the following written description and the various features and advantageous details thereof, are explained more fully with reference to the non-limiting examples included in the accompanying drawings and as detailed in the description, which follows. Descriptions of well-known components have been omitted so to not unnecessarily obscure the principle features described herein. The examples used in the following description are intended to facilitate an understanding of the ways in which the disclosure can be implemented and practiced. Accordingly, these examples should not be construed as limiting the scope of the claims.

### Prior Art

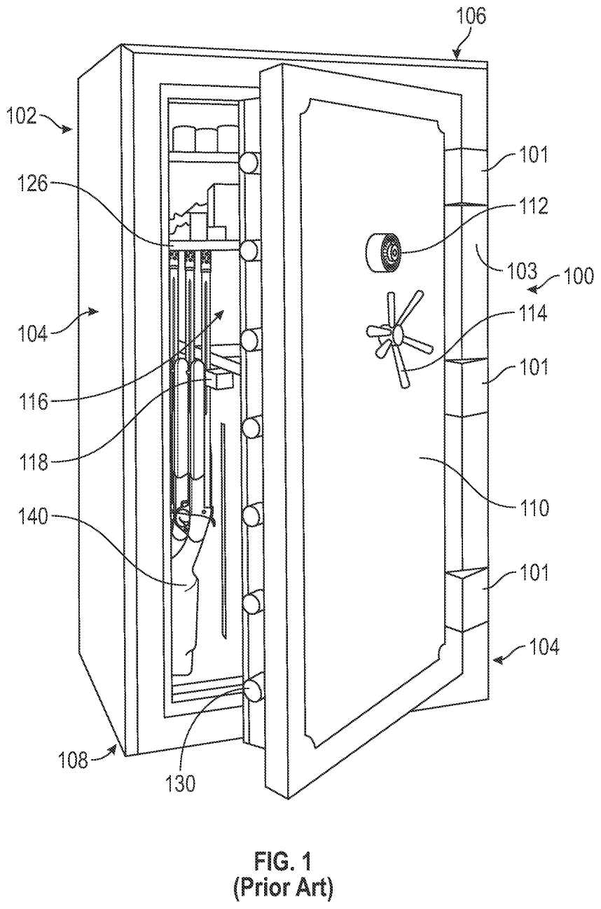

FIG. 1 depicts a traditional prior art secure firearm storage system or “safe” 100. Safe 100 had a front-facing door 102 connected to the front 103 of the safe via hinges 101. The safe 100 also includes sides 104, a top 106, and a bottom 108, which collectively define an enclosure 116. Door 102 may comprise a locking mechanism 112 and an engagement wheel or external actuator such as wheel 114 or other mechanism such as an actuator lever (not shown) for actuating lugs 130 to remove the lugs from engagement with lug apertures (not shown) in the front 103 to secure the door 102 to the safe 100 when the locking mechanism 112 is unlocked. Safe 100 may include shelves 126 and racks 118 within enclosure 116.

Significant problems exist in the traditional safe 100. Significantly, the only manner in which long guns such as shotgun 140 may be stored in safe 100 is by placing each firearm from the front 103 of safe 100 when door 102 is swung open on hinges 101. This is problematic because access to the long guns placed first into safe 100 may typically not be removed without first removing long guns 140 placed into the enclosure 116 after the first long gun 140 was placed.

### Detailed Specification

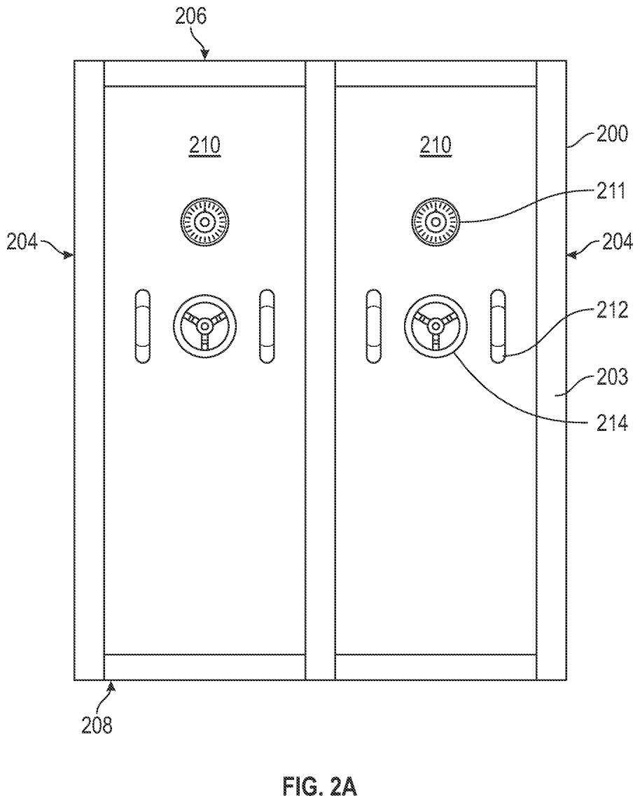

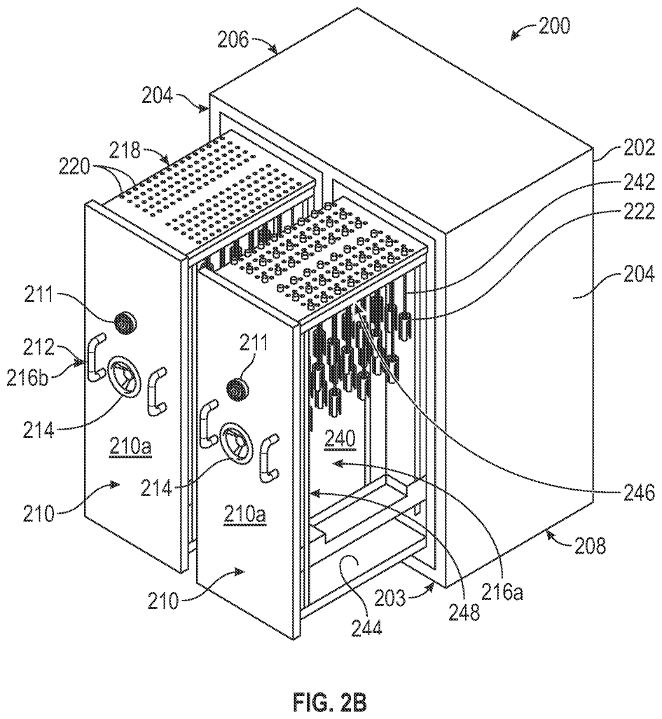

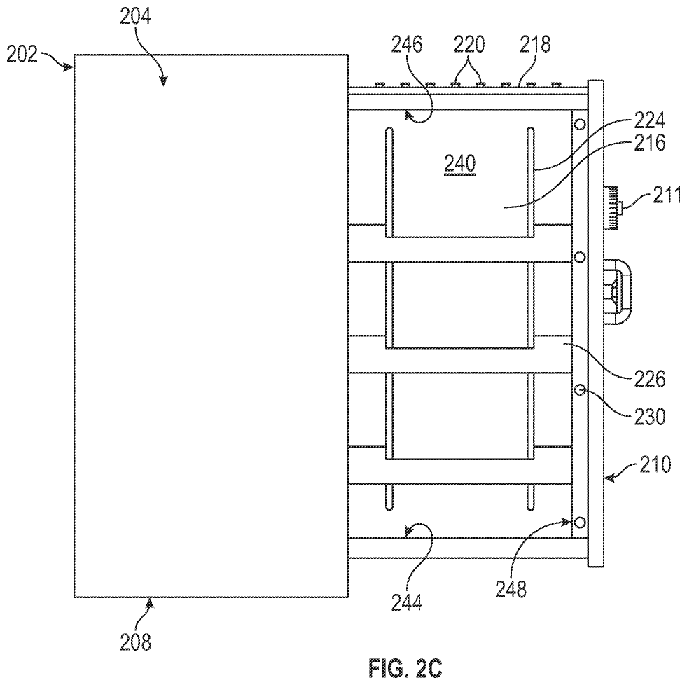

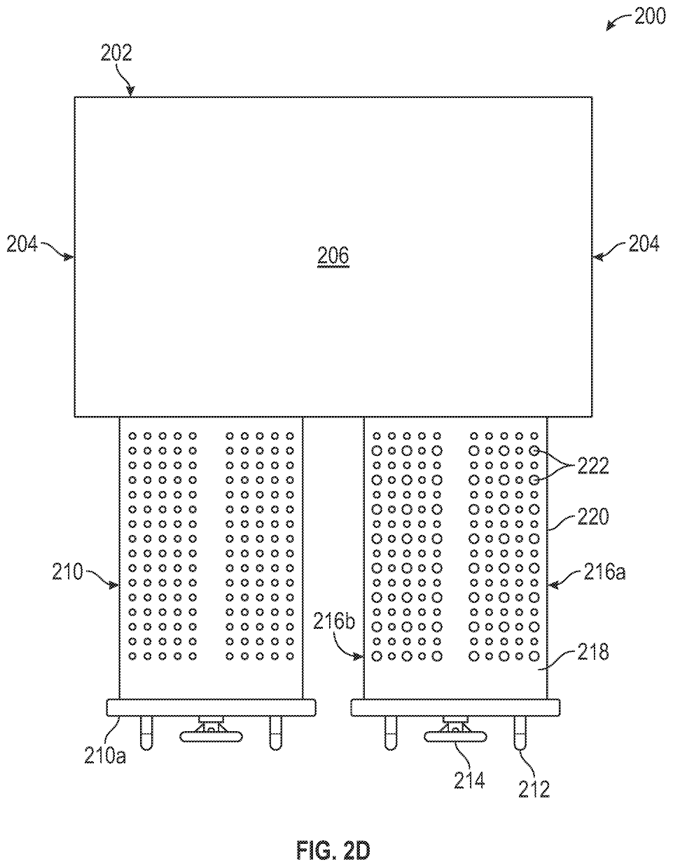

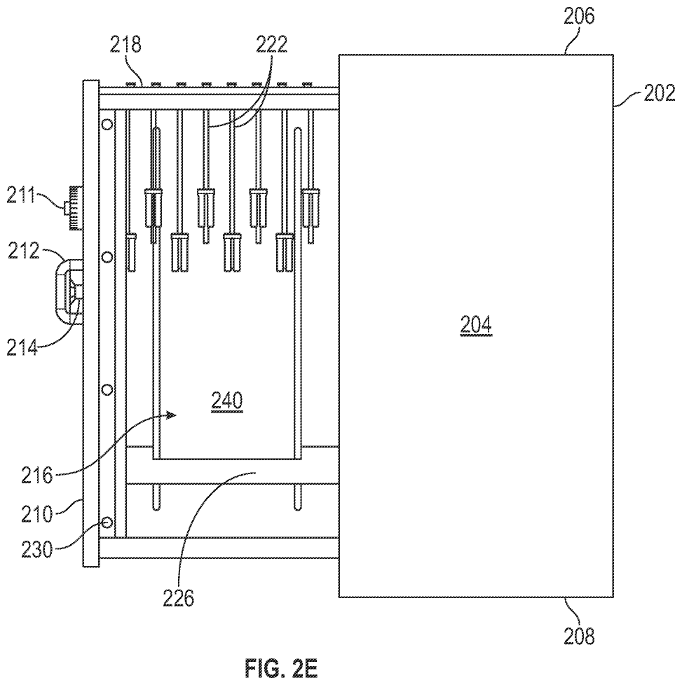

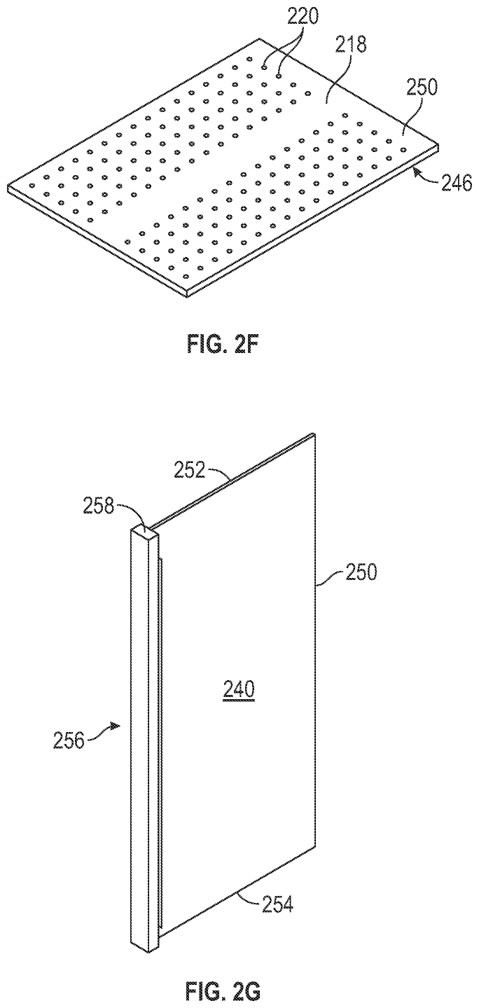

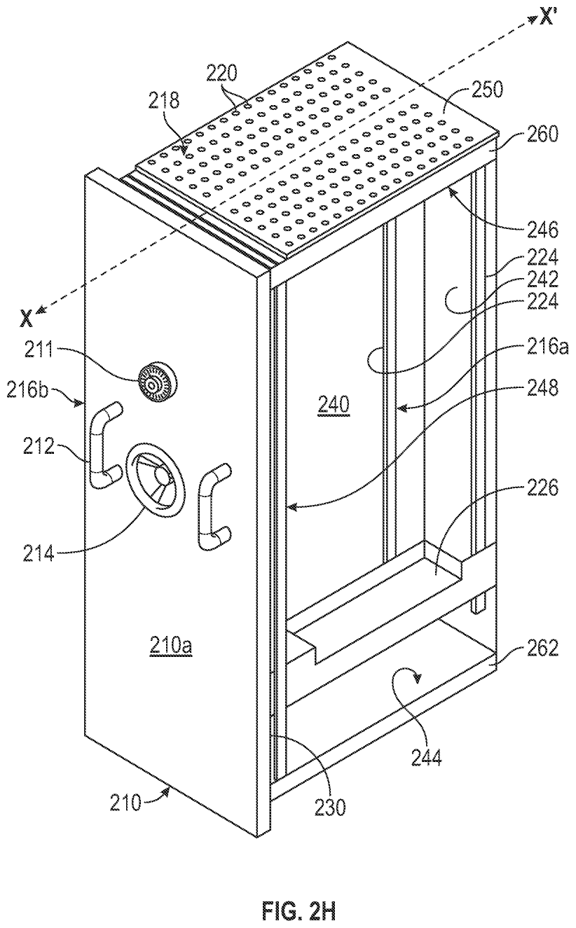

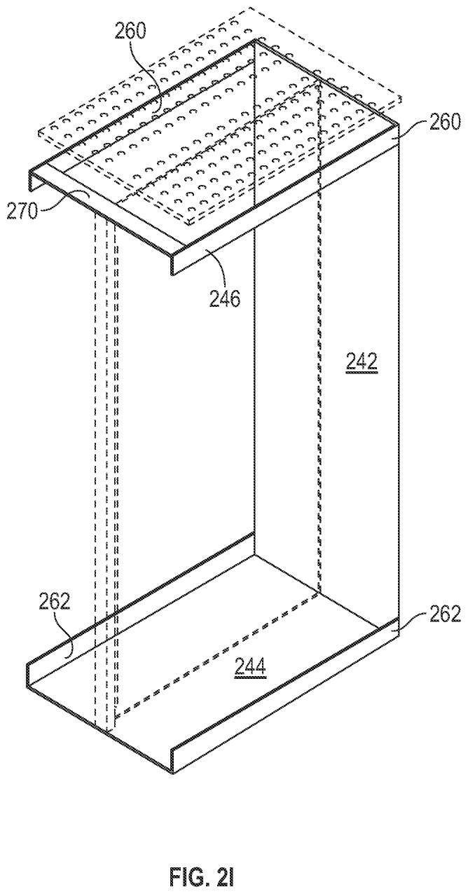

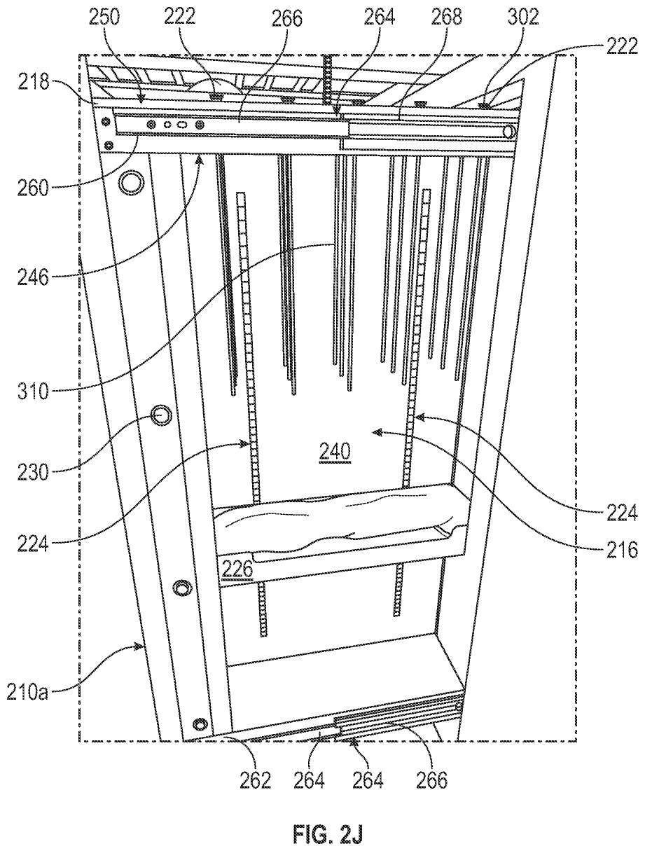

FIGS. 2A-2J discuss a system for firearm storage 200 that solves the centuries-old problem created by a hinged door safe 100 as shown in FIG. 1. FIGS. 2A, 2B, and 2C illustrate front, perspective, and top views, respectively, of an example of a safe 200 in accordance with an embodiment of the present invention. Safe 200 includes a back wall 202, a front face 203, sides 204, top 206 and a bottom 208, which in the embodiment shown form a cuboid structure that includes an interior space 216. It will be understood that safe 200 could take on any of a number of three-dimensional geometric shapes that form an enclosable interior space like interior space 216 for securing items therein without departing from the spirit and scope of this disclosure. Safe 200 further includes at least one drawer 210 (two shown in FIGS. 2A-2C), which is shown and described in more detail in FIGS. 2D-2J. As illustrated, drawer 210 includes an exterior face 210a, where a locking mechanism 211, such as a dial- or electronic combination lock may be located, as is known in the art. Additionally, pulls 212 for actuating drawer 210 into an open or closed position, and an engagement actuator 214 may be included, which allows lugs 230 to be disengaged or engaged within lug apertures (not shown) in opposing surfaces of front face 203 when the drawer 210 is fully pushed into interior space 216. Preferably, for security, each of the lugs 230 correspond to lug apertures located along the interior face of front 203 of the safe 200, such that lugs 230 are engaged with the cuboid structure adjacent to the sides 204, top 206, and bottom 208. Additionally, but also not shown, a fire-retardant material (not shown), such as sheetrock or other heat attenuating material, may line the interior space 216 of the safe 200 to protect the contents of safe 200 in the event of a fire.

FIGS. 2F-2J show drawer 210 in more detail. For example, drawer 10 may include a divider 240 that is parallel to the axis x-x′ defined by the front and back of interior space 216 of safe 200. In such a case as shown, the divider 240 may define opposing interior spaces 216a and 216b (see also FIGS. 2B, 2D). In other embodiments, a single interior space 216 may be used, as a matter of design choice and scale. Interior space 216 may include shelf brackets 224 affixed to divider 240 and/or the inside surface 248 of front face 210 or the rear surface 242 of drawer 210 to facilitate the mounting of shelves 226. Drawer 210 further includes a bottom surface 244 and top rack 218 having apertures 220. Further, the drawer 210 may include top rails 260 and bottom rails 262. Drawer 210 may be actuated along guides 264 (FIG. 2J) mounted on top rails 260 and bottom rails 262. In the embodiment shown, the guides 264 are telescoping bearing guides, but any suitable method for facilitating actuation of drawer 210 may be used. Top rack 218 may be affixed to top rails 260, in addition to front span 270 and a flange 272 of rear drawer surface 242. Alternatively, the top rack 218 may be affixed to the divider 240, the inside surface 248 and/or the rear surface 242, either directly using common hardware or brackets.

As shown in FIGS. 2B, and 2E, drawer 210 may also include one or more guide rod systems 222 for securing long guns, such as long gun 140 (from FIG. 1) in a substantially vertical orientation within interior space 216 of drawer 210, with each aperture 220 of top rack 218 sized to accommodate a guide rod system 222.

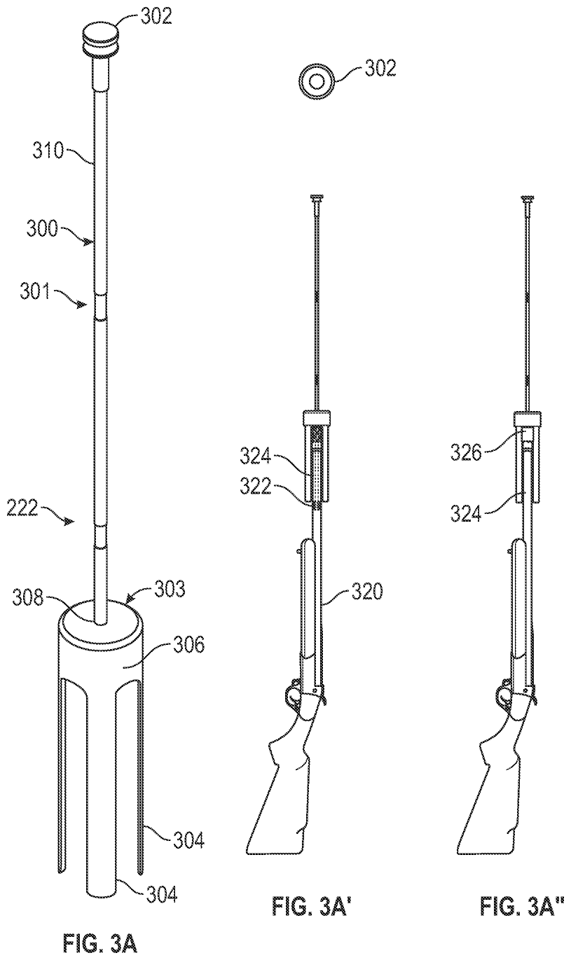

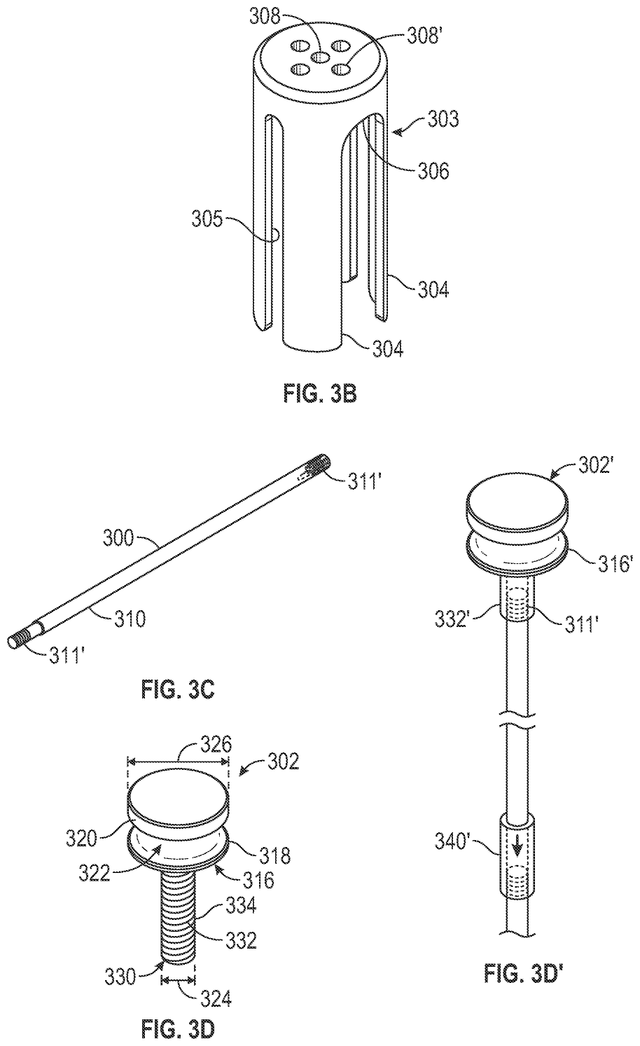

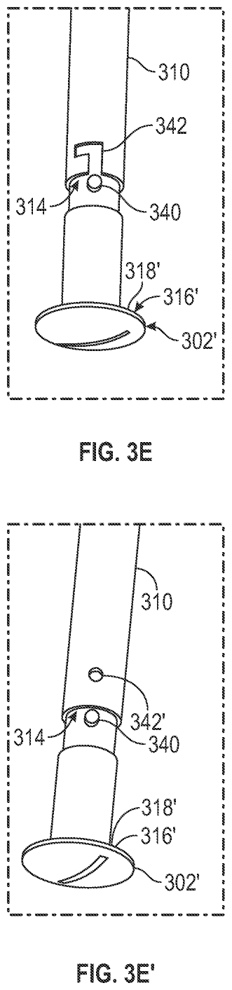

The guide rod systems 222 are described more fully in view of the illustrations in FIGS. 3A-3D′. Each guide rod system includes a guide rod 300 that may include one or more guide rod sections 310. The guide rod sections 310 may be configured to connect and disconnect to other guide rod sections 310 to facilitate shorter or longer long guns 140 (a longer guide rod 300 being necessary to vertically secure a shorter long gun within interior space 216). Each guide rod section 310 may include a male section 312 and a female section 314, wherein the male section 312 of one guide rod section 310 is sized to connectable insert into the female section 314 of another guide rod section 310. In the embodiment shown in FIG. 3C, the male section 312 and female section 314 uses threaded portions 313 and 315, respectively, to facilitate connection. In other embodiments, a simple push/pull orientation could be used to connect a male section 312 to a female section 314. In yet another embodiment, a detent 340 at a male end 312 of guide rod section 310 may be operable to be inserted into a push-turn groove 342 in the female section 314 of another guide rod section 310. Other connections between guide rod sections 310 are likewise within the scope and spirit of this disclosure, including, without limitation, tent-pole connectors, sleeve connectors, magnetic connections, and snap connectors.

The guide rod system may also include a guide rod cap 302. The guide rod sections 310 have a diameter smaller than the diameter of the apertures 220 of top rack 218, and in certain embodiments, smaller than the caliber or bore of a long gun, so that at least one rod section may be inserted into the bore of a long gun to secure the long gun in a substantially vertical orientation within the interior space 216, and also allows the guide rod sections 310 to be inserted either through the top surface 250 or the bottom surface 246 of top rack 218.

As shown in FIGS. 3C-3D, the top cap 302 may include a male section 330 having connector 332, which may be threaded (shown) or may have a push and turn connector or detent, as shown in FIGS. 3E and 3E′, respectively. It should be understood that the top cap 302 may be configured with either a male connector 312 or a female connector 314 that is operable to connect to a female or male connection, respectively, of a guide rod section 310. The top cap 302′ as shown in FIG. 3D′ may also be configured without threads as a friction connector 332′, which can be a hollow protrusion from the flange 316′, operable to accept either rod end 311′ of guide rod section 310′ as shown in FIG. 3C′. In operation, the rod end 311′ of a guide rod section 310′ is inserted into the friction connector 332′, with both the friction connector 332′ and the rod end 311′ sized to create a removable friction connection to each other when the rod end 311′ is inserted into the friction connector 332′, such as the connection of a common multi-piece fishing rod. This configuration may also be extended by using a coupler 340′, such that multiple sections of guide rod sections 310′ may be connected to one another to extend the length of the guide rod system. It should be understood that the friction connection shown in FIG. 3D′ may also be implemented using a male friction connector 332′ (not shown), such that the rod end 311′ includes a hollow portion (not shown) operable to receive the male friction connector 332′. Likewise, the coupler 340′ may be a male configuration (not shown) operable to be inserted into an end of two connection guide rod sections 310′.

The top cap 302 includes a flange 316 that has a diameter larger than aperture 220, such that top cap 302 cannot pass through an aperture 220 but a guide rod section 310 may pass through an aperture 220. The top cap 302 may be integral (i.e., not removable from) a guide rod section 310, or it may be removable from the guide rod section 310. In the case of an integral guide rod and top cap (not shown), the guide rod may only be inserted from above the top rack 218 when the drawer 210 is actuated into an open position. Conversely, with a removable top cap 302, one or more guide rod sections 310 may be inserted from the bottom 246 of top rack 218 through an aperture 220 and then connected to top cap 302 or may be inserted from the top surface of top rack through an aperture 220 thereof, thus increasing the storage versatility and configurability of the storage solutions possible with the present invention.

The guide rod system may also include a barrel stabilizer 303. In the embodiments shown, the barrel stabilizer 303 is shown in a generally cylindrical shape, but may be sized a shape to accommodate the muzzle shapes of any number of different types of long guns. For example a cylindrical shape may not be suitable to protect the exterior of a double-barreled shotgun or rifle, and therefore may have a more “figure eight”-like profile to accommodate such a device. The barrel stabilizer preferable includes a top portion 307, a side wall 304, and one or more cut-out portions 305. One or more apertures 308 are disposed through the top portion (which may be flat, spoked, or any other configuration that permits an aperture 308 to be disposed therethrough to accommodate at least one guide rod section 310. In operation, the barrel stabilizer 303 is configured to be disposed about the exterior surface of the barrel of a long gun 320 as shown in FIG. 3A′ while the guide rod section 310 is inserted within the bore 322 of the long gun 320, such that the barrel stabilizer 303 may operate with the inserted guide rod section 310 of the guide rod system 300 to secure the muzzle of a long gun 320 from both the interior bore 322 and the exterior of the barrel 324. While the barrel stabilizer guide rod sections 310, top cap 302, and barrel stabilizer 303 may be manufactured of any suitable rigid or semi-rigid material such as plastic, carbon fiber, fiberglass, metal, Kevlar®, wood, etc., in a preferred embodiment, any material in contact within contact of the barrel 324 or bore 322 of a long gun 320 has a hardness that is less than that of the material of either, to prevent undesired scratching or damage to the exterior or interior surfaces of the long gun 320. Additionally, the surfaces of the guide rod sections 310 and/or the barrel stabilizer 303 may be coated with a soft or cushioning material such as foam, non-marring ceramic, such as Cerakote®, rubber, plastic, or other material to prevent scratching or damage to a long gun.

In yet another embodiment, a bottom cap 326 may be affixed to a bottom portion of a guide rode section 310 inserted through an aperture 308 of a barrel stabilizer 303, such that only the barrel stabilizer 303 holds the long gun 320 in a substantially vertical orientation. This embodiment may be desirable when storing extremely valuable, antique, or fragile long guns.

As previously stated, the storage system described herein is versatile in the manner in which long guns, such as long gun 320 are secured within the interior space 216 of the safe 200. For example, the barrel stabilizer 303 may be affixed over the muzzle of a long gun 320, then a sufficient length of guide rod sections 310—a length sufficient to be inserted into the muzzle 322 of long gun 320 when the top cap 302 is resting on the top surface 250 of top rack 218—having a top cap 302 affixed thereto may be inserted from above the top rack 218 through an aperture 220, through an aperture 308 in the barrel stabilizer 303 and into the bore 322 of a long gun 320. Alternatively, a sufficient length of guide rod sections 310 may be inserted into the bore 322 of a long gun 320, with or without a barrel stabilizer, and inserted through the bottom surface 246 of top rack 218, whereupon a top cap 302 may be affixed to the portion of the guide rod 310 inserted through the aperture to secure the guide rod 310 between the top cap 302, top rack 218, and bore of long gun 320.

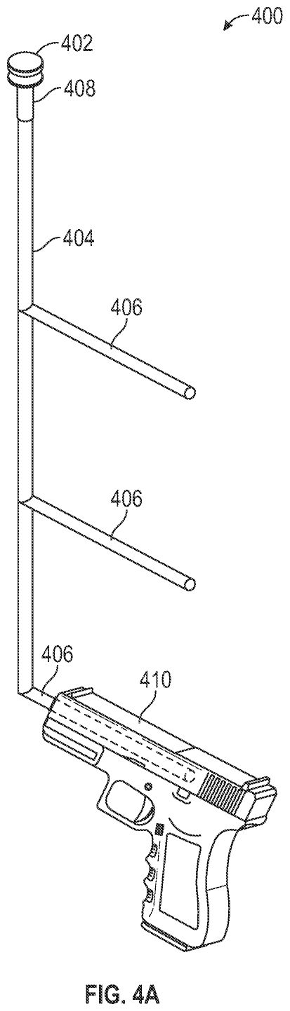

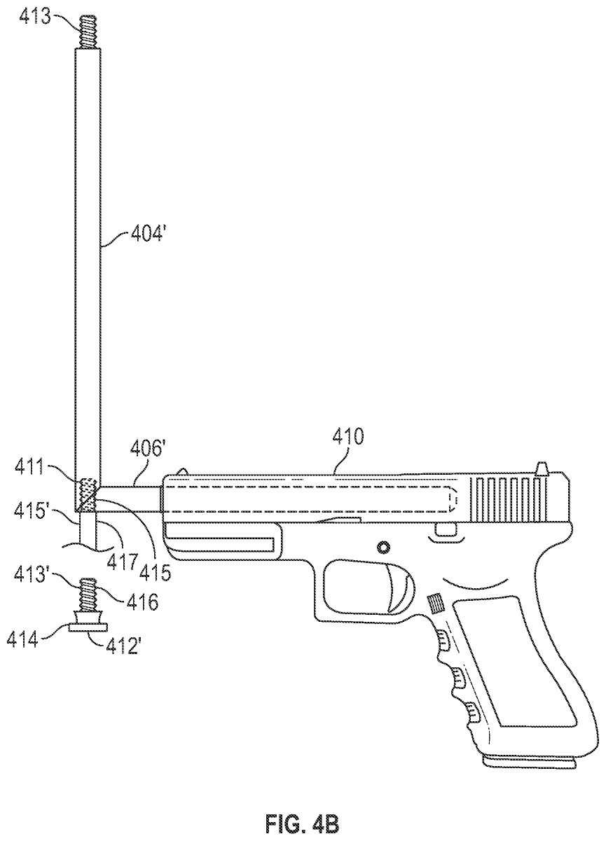

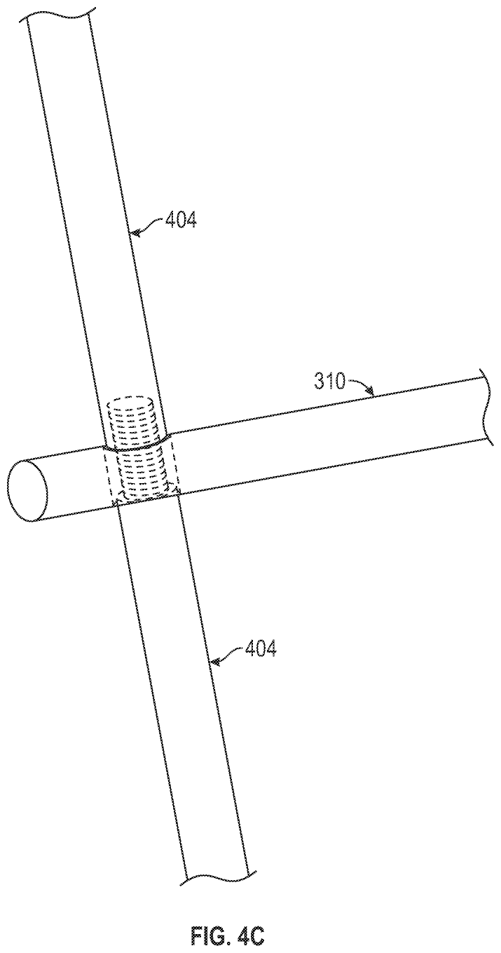

Yet another aspect of the invention includes a handgun storage system 400 as illustrated in FIGS. 4, 4A, and 4B. The handgun storage system 400 includes a top cap 402, which may include a connector 408 for connecting with a guide rod section 404 in the same manners described above with respect to top cap 302 and guide rod sections 310 of the guide rod storage system 222 described in reference to FIGS. 3A-3E. Additionally, handgun storage system 400 operates with top rack 218 in the same manner as the guide rod system 222. However, due to the inherent short barrel length of handguns, such as handgun 410 shown in FIG. 4, system 400 uses lateral guide rods 406 operable to connect to substantially guide rod sections 404, which are substantially vertical. Lateral guide sections 406 may be at a 900 angle relative to vertical, or may be less than 90°, such that when a lateral guide rod 406 is inserted into the bore of a handgun 410, the handgun 410 is retained on the lateral guide rod by its bore resting thereupon.

Multiple lateral guide sections 406 may be installed using a single top cap 402 by alternatively affixing vertical guide rods 404 and lateral guide rods 406 below top cap 402. As shown by the enlarged section of FIG. 4A in FIG. 4B, this configuration may use matching angled faces at θ′, and then inserting a threaded male portion 413 through a female threaded aperture 415 of lateral guide rod 406 into a female threaded portion 411 of vertical guide rod 404′. To secure the lateral guide rod 406 that is distal from top cap 402, a bottom cap screw 412 having a flange and male threaded end 416 may be threaded into a female threaded aperture 415 of the most distal vertical guide rod 404 from the top cap 402.

Alternatively, the lateral guide rods 406 may have an aperture therethrough that allows a male threaded end 413 of a vertical guide rod to be inserted therethrough and into a female threaded aperture of the next proximal vertical guide rod 404 relative to the top cap 402, until the desired number of lateral guide rods 406 have been configured below top cap 402, whereupon a bottom cap screw 412 may be inserted into the female threaded portion 415 of the most distal vertical guide rod through an aperture 417 of the most distal lateral guide rod 406.

The present disclosure offers several advantages:
1. Providing access to any long gun or handgun within a storage enclosure with minimal or no removal of any other stored long gun or handgun;
2. Increasing the storage capacity of a firearm safe, and in some cases (depending on size) more than fifty percent (50%), while permitting ease of access to each stored item;
3. Providing a vertical storage system that protects the interior and exterior of the barrels of long guns and handguns stored using the system.

Other advantages will be obvious to those skilled in the relevant art. Various configurations disclosed in this specification are exemplary in nature, and are not intended to be limiting in scope or breadth within the spirit of the disclosure.

We claim:

1. A secure firearm storage system, comprising:
a housing with a top, bottom, front and sides defining an interior enclosure;
a drawer operable to be disposed within the interior enclosure, the drawer comprising a front surface, a bottom surface, and a rear surface;
at least one guide configured to facilitate pulling the drawer open and pushing the drawer closed;
a lock operable to disengage at least one lug disposed in the front surface from at least one aperture disposed in the front of the housing;
wherein pulling the drawer open and pushing the drawer closed comprises moving the entire front surface of the drawer a uniform linear distance relative to the front of the housing and the back of the housing.

2. The system of claim 1, further comprising a fire-retardant material disposed between at least one of the top, bottom, front, and sides and the interior disclosure;

3. The system of claim 2, wherein the locking mechanism comprises a combination lock and an engagement actuator in communication with the at least one lug, wherein entering the correct combination into the combination lock permits turning the engagement wheel to disengage the at least one lug from the at least one aperture in the front of the housing.

4. The system of claim 3, wherein the at least one guide is a telescoping bearing guide operable to guide the drawer into an open position when a force is applied to the drawer in a direction away from the front of the housing in the direction defined by the telescoping bearing guide.

5. The system of claim 1, wherein the drawer further comprises a:
a top rack disposed opposite the bottom surface of the drawer, wherein the top rack includes at least one aperture therethrough; and
at least one guide rod system, the guide rod system further comprising at least one guide rod section and a top cap, wherein the at least one guide rod section has a diameter narrower than the at least one aperture, and is configured to be inserted through one of the at least one aperture, and the top cap is configured to rest on a top surface of the top rack without passing through the aperture.

6. The system of claim 5, wherein the at least one guide rod is configured to secure a long gun that includes a barrel with a muzzle and a bore within the barrel, wherein the barrel and the bore are in a substantially vertical orientation relative to the linear travel of the drawer, and wherein the long gun is secured when the at least one guide rod is disposed within the bore of the muzzle, and the top cap is resting on the top surface of the top rack.

7. The system of claim 6, further comprising:
a barrel stabilizer that includes a top surface with an aperture therethrough, an outer side surface, and an inner side surface, wherein
the inner side surface of the barrel stabilizer is configured to enshroud at least a portion of the outside of the barrel of the long gun, the aperture in the top surface has a diameter greater than the diameter of the at least one guide rod, and the guide rod maintains the barrel stabilizer in a stable relationship with the barrel of the long gun when the at least one guide rod is inserted through the aperture in the barrel stabilizer into the bore of the barrel.

8. The system of claim 5, wherein the at least one guide rod is removably connected to the top cap.

9. The system of claim 5, wherein the at least one guide rod comprises at least two guide sections removably connected to each other, and wherein at least one of the at least two guide rod sections is removably connectible to the top cap.

10. The system of claim 6, further comprising
a barrel stabilizer, that includes a top surface with an aperture therethrough, an outer side surface, and an inner side surface, and
a bottom cap, wherein the at least one guide rod is configured to be inserted through the aperture in the top surface of the barrel stabilizer, and
wherein the bottom cap is configured to be removably connected to the at least one guide rod, and wherein the barrel stabilizer is configured to maintain the barrel of the long gun in a substantially vertical configuration when the inside surface of the barrel stabilizer is placed over the muzzle of the barrel of the long gun.

11. A firearm storage system, comprising:
a top rack configured to be disposed within a firearm safe, and including a top surface, a plurality of apertures, and a bottom surface;
at least one guide rod section including a connector and a diameter smaller than the diameter of the plurality of apertures;
a top cap comprising a flange, a connector operable to removably connect the at least one guide rod section; and
wherein the flange of the top cap has a diameter greater than the diameter of the plurality of apertures, the diameter of the at least one guide rod section is smaller than a diameter of a bore of a barrel of a firearm, and wherein the guide rod secures the firearm in a substantial vertical orientation when the top cap rests against the top surface of the top rack, the at least one guide rod is removably connected to the top cap, and the at least one guide rod is disposed through one of the plurality of apertures into the bore of the barrel of the firearm.

12. A firearm stabilization system, comprising:
a guide rod system, the guide rod system further comprising at least one guide rod section and a top cap;
wherein the at least one guide rod section is operable to be inserted through an aperture of a top rack disposed opposite an interior bottom surface of a firearm safe, and the top cap is configured to rest on a top surface of the top rack without passing through the aperture.

13. The system of claim 12, wherein the at least one guide rod is configured to secure a long gun that includes a barrel with a muzzle and a bore within the barrel, wherein the barrel and the bore are in a substantially normal relationship with the top rack, and wherein the long gun is secured when the at least one guide rod is disposed within the bore of the muzzle, and the top cap is resting on the top surface of the top rack.

14. The system of claim 13, further comprising:
a barrel stabilizer that includes a top surface with an aperture therethrough, an outer side surface, and an inner side surface, wherein
the inner side surface of the barrel stabilizer is configured to enshroud at least a portion of the outside of the barrel of the long gun, the aperture in the top surface has a diameter greater than the diameter of the at least one guide rod, and the guide rod maintains the barrel stabilizer in a stable relationship with the barrel of the long gun when the at least one guide rod is inserted through the aperture in the barrel stabilizer into the bore of the barrel.

15. The system of claim 14, wherein the at least one guide rod is removably connected to the top cap.

16. The system of claim 15, wherein the at least one guide rod comprises at least two guide sections removably connected to each other, and wherein at least one of the at least two guide rod sections is removably connectible to the top cap.

17. The system of claim 14, further comprising
a barrel stabilizer, that includes a top surface with an aperture therethrough, an outer side surface, and an inner side surface, and
a bottom cap, wherein the at least one guide rod is configured to be inserted through the aperture in the top surface of the barrel stabilizer, and
wherein the bottom cap is configured to be removably connected to the at least one guide rod, and wherein the barrel stabilizer is configured to maintain the barrel of the long gun in a substantially vertical configuration when the inside surface of the barrel stabilizer is placed over the muzzle of the barrel of the long gun.

18. The system of claim 15, wherein the at least one guide rod is removably connected to the top cap via a connection consisting of one of a friction connection, a threaded connection, a push-and-turn connection, or a detent connection.

19. The system of claim 16, wherein the at least one guide rod is removably connected to another a guide rod section via a connection consisting of one of a friction connection, a threaded connection, a push-and-turn connection, or a detent connection.
